(19) United States
(12) Patent Application Publication
(10) Pub. No.: US 2008/0218498 A1
(43) Pub. Date: Sep. 11, 2008

(54) IMAGE DISPLAY CONTROL DEVICE AND IMAGE DISPLAY CONTROL METHOD

(75) Inventors: Seiji Yoshioka, Higashiosaka-shi (JP); Tomoaki Uzu, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/040,334

(22) Filed: Feb. 29, 2008

(30) Foreign Application Priority Data
Mar. 5, 2007 (JP) 2007-054123

(51) Int. Cl. G09G 5/00

(52) U.S. Cl. 345/204

(57) ABSTRACT

An image display control device, which can communicate with an image formation device having an authentication function, an imaging device for acquiring an image of an operator of the image formation device, and a recording management server for storing the acquired image respectively through a network, comprises: a first display unit to display an authentication history list of the image formation device; a selection unit to select an authentication history from the displayed authentication history list; a display condition setting unit to set a condition for displaying the stored image; and a second display unit to display the stored image from a display start position of the image determined based on an authentication hour specified from the selected authentication history and a pre-reproduction time included in the set condition and indicating a time for reproducing the image retroactively from the authentication hour.

### BACKGROUND OF THE INVENTION

1. Field of the Invention

The present invention relates to an image display control device and an image display control method. More specifically, the present invention relates to the device and the method for displaying a recorded image from an authentication history of an image formation device.

2. Description of the Related Art

In recent years, to improve security for a multifunction device placed in an office, the multifunction device of a type having an IC card authentication function has spread. For example, as shown in Japanese Patent Application Laid-Open No. 2006-099714, if a user brings an IC card close to a card reader provided on a multifunction device, information such as a user name, a password and the like recorded in the IC card is read, access authentication is executed based on the read information, and then an access right is managed. In such a system, the user can execute a printing process to print data that he/she registered in the multifunction device, by only bringing the IC card close to the multifunction device.

Also, the user can log in the multifunction device without using the IC card. That is, the user can access the multifunction device by inputting the user name and the password thereof through a touch panel.

However, in such a case, if the user name and the password are known, it is possible to access the information in the multifunction device, and it is also possible to execute the printing process to the accessed information. For this reason, an access history is saved. Thus, if the user names and access times are saved as the access history in the multifunction device or a management server, it is possible for its manager or administrator to confirm who accessed the multifunction device and when the users accessed the multifunction device.

However, if the IC card is lost or the user name and/or the password are/is unwillingly or erroneously leaked, it is impossible, only by the access history, to specify who actually accessed the multifunction device.

On the other hand, in recent years, a network camera, which can be operated and controlled through a network, has come into wide use. For example, Japanese Patent Application Laid-Open No. 2006-279464 discloses that a frame rate is increased according to a detected event when it is detected that a subject in image recording moves, while the frame rate is lowered when it is not detected that the subject moves.

As described above, in order to improve security relevant to the accessing to the multifunction device, a system, which records operators (users) of the multifunction device by using a network camera, is conceivable.

Here, according to the technique disclosed in Japanese Patent Application Laid-Open No. 2006-279464, it is possible to increase the frame rate only when the operators (users) operate the multifunction device, as continuously recording them. Accordingly, it is possible to more certainly use the acquired and recorded images.

However, it is not easy to extract, from the long-time recorded image (video), the image in a time zone that the manager or the administrator requires. For example, even in case of causing to display only the images of the time zones of the high frame rate, if the multifunction device is used by many users, it is necessary for the manager or the administrator to confirm a large number of images. Accordingly, the above-described system is not suitable for such a direction for use.

### SUMMARY OF THE INVENTION

In consideration of such a conventional problem as described above, the present invention provides a mechanism for displaying, from an authentication history of an image formation device, an image acquired at a desired hour in a simple operation.

The present invention provides an image display control device which can communicate with an image formation device having an authentication function, an imaging device for acquiring an image of an operator of the image formation device, and a recording management server for storing the image acquired by the imaging device respectively through a network, the image display control device comprising: a first display unit configured to display an authentication history list of the image formation device; a selection unit configured to select an authentication history from the authentication history list displayed by the first display unit; a display condition setting unit configured to set a condition for displaying the image stored in the recording management server; and a second display unit configured to display the image stored in the recording management server, from a display start position of the image which is determined based on an authentication hour specified from the authentication history selected by the selection unit and a pre-reproduction time included in the condition set by the display condition setting unit and indicating a time for reproducing the image retroactively from the authentication hour.

According to the present invention, it is possible to display, from the authentication history of the image formation device, the image acquired at the desired hour in a simple operation.

Such an object as described above and another object of the present invention will become apparent from the following description of exemplary embodiments with reference to the attached drawings.

### BRIEF DESCRIPTION OF THE DRAWINGS

FIG. 1 is a block diagram illustrating an example of a network configuration of an information processing system which includes an image display control device and an image formation device (for example, a digital copying machine), according to a first embodiment of the present invention.

FIG. 2 is a block diagram illustrating the constitutions of a client PC 101, an image display control device 103, an authentication server 104 and an image formation device 105, respectively illustrated in FIG. 1.

FIG. 3 is a flow chart for describing an example of a first control processing operation in the information processing system.

FIG. 4 is a schematic diagram for describing an example of a screen for setting a recording schedule in the information processing system.

FIG. 5 is a flow chart for describing an example of a second control processing operation in the information processing system.

FIG. 6 is a function diagram for describing functions of the image display control device 103.

FIG. 7 is a schematic diagram illustrating an example of a screen for setting an authentication list, list display conditions and recording operation conditions of the image display control device 103.

FIG. 8 is a schematic diagram for describing a viewer screen to be displayed based on a network camera viewer application 601.

FIG. 9 is a flow chart for describing an example of a third control processing operation in the information processing system.

FIG. 10 is a flow chart for describing an example of a fourth control processing operation in the information processing system.

FIG. 11 is a flow chart for describing an example of a fifth control processing operation in the information processing system.

FIG. 12 is a diagram for describing a memory map of a recording medium (or a storage medium) on which various data processing programs capable of being read by the devices constituting the information processing system.

### DESCRIPTION OF THE EMBODIMENTS

### First Embodiment

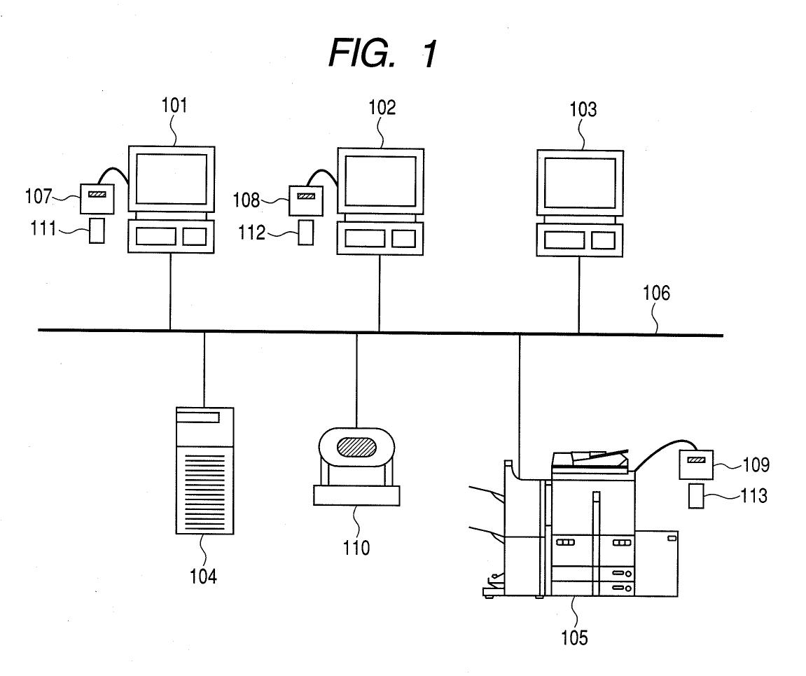

FIG. 1 is a block diagram illustrating an example of a network configuration of an information processing system which includes an image display control device and an image formation device (for example, a digital copying machine), according to the first embodiment of the present invention.

In the information processing system illustrated in FIG. 1, plural client computers {hereinafter, called a (first) client PC 101 and a (second) client PC 102}, an image display control device 103 according to the present invention, an authentication server 104 for managing user information, an image formation device 105, and a network camera 110 acting as an imaging device are mutually connected to others through a network 106 such as a LAN (local area network).

The first client PC 101 is equipped with an IC card reader 107 for reading an IC card 111 storing therein user identification information. Also, the second client PC 102 is equipped with an IC card reader 108 for reading an IC card 112 storing therein user identification information.

An IC card reader 109, which can be optionally connected to the image formation device 105, can read the IC cards 111 and 112 (generically called an IC card 113).

Here, it is assumed that the network camera 110, which shoots and acquires images of the operation unit of the image formation device 105 and its vicinity, is set on the system so as to be able to recognize a user who operates the image formation device 105. The network camera 110 shoots and acquires the images of the operation unit of the image formation device and its vicinity in the direction that the camera has been set, at preset panning, tilting and zooming angles, at a preset frame rate and at preset resolution. Then, the network camera 110 transmits the acquired image to the authentication server 104 according to a certain protocol such as a UDP (User Datagram Protocol). The authentication server 104 also functions as a recording management server for storing therein the shot and acquired images. Here, it should be noted that, of course, the present invention is not limited to the configuration that the authentication server 104 also acts as the recording management server. That is, the recording management server may be provided independently of the authentication server.

Further, although FIG. 1 illustrates the single network camera 110 acting as the imaging device and the single image formation device 105, the plural network cameras and the plural image formation devices may be provided in the network system according to the present invention.

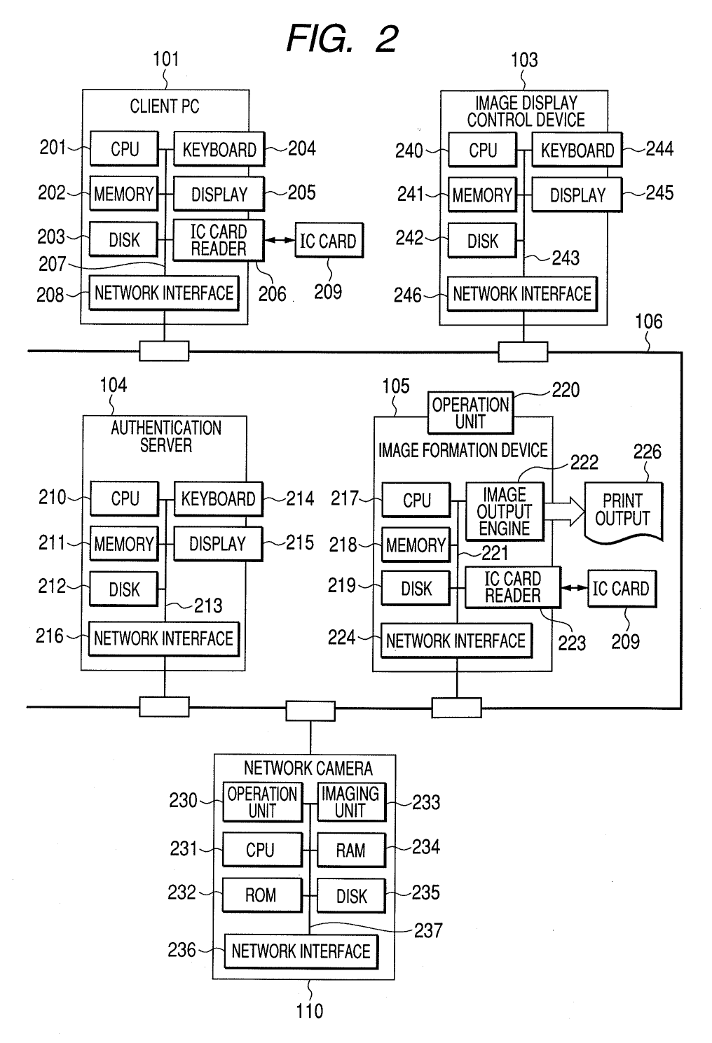

FIG. 2 is a block diagram for describing the constitutions of the client PC 101, the image display control device 103, the authentication server 104 and the image formation device 105, respectively illustrated in FIG. 1. It should be noted that, in FIG. 2, the same parts as those in FIG. 1 are denoted by the same reference numerals as those in FIG. 1, respectively. Incidentally, since the constitution of the first client PC 101 is the same as that of the second client PC 102, FIG. 2 illustrates only the first client PC (also, called a first computer hereinafter) 101 for simplification.

In FIG. 2, the first computer 101 concretely includes a CPU 201 for controlling the whole of the first computer 101, a memory 202, a disk 203, a keyboard 204, a display 205, an IC card reader 206, and a network interface 208, which are mutually connected to others through an internal bus 207.

When the CPU 201 executes a calculation, the memory 202 temporarily stores therein the result of the calculation. The disk 203, which is made of a storage device such as an HDD (hard disk drive) or the like, stores therein programs and data. The keyboard 204 is used for inputting various data, and the display 205 displays various kinds of information such as information input by using the keyboard 204. If an IC card 209 (corresponding to the IC card 111 in FIG. 1) is inserted into the first computer 101, the IC card reader 206 (corresponding to the IC card reader 109 in FIG. 1) reads a user name and a password written on the inserted IC card. The network interface 208, which is connected to the network 106, is the interface for communicating with the respective devices on the information processing system. Here, it should be noted that, in the present embodiment, it is possible to use either a contact type IC card or a non-contact type IC card as the IC card. Moreover, it is assumed that a magnetic card or an optical card can be used instead of the IC card. In such a case, it is necessary to provide, instead of the IC card reader, a device for reading the magnetic card or the optical card.

The authentication server 104 includes a CPU 210 having the same function as that of the first computer 101, a memory 211, a disk 212, a keyboard 214, a display 215, and a network interface 216, which are mutually connected to others through an internal bus 213.

More specifically, user identification information of each user who uses the information processing system (or a printing system), and access authority information indicating the function permitted by the image formation device 105 have been stored in the disk 212 of the authentication server 104.

Also, an authentication program has been stored in the disk 212. Here, the authentication program is the program which is used to, in a case where a log-in request authenticated by the IC card is received from the image formation device 105 by the authentication server 104, compare the user identification information read from the IC card 209 by the IC card reader 223 with user identification information (that is, a user name and a password) stored in the disk 212, and determine based on the compared result whether or not to permit an access from the image formation device 105. Further, in the authentication server 104, an authentication history which includes the user identification information, an authentication hour, the authentication result (OK/NG), and a device ID for identifying the image formation device is stored in the disk 212 according to such an authentication process as described above.

Furthermore, image data received from the network camera 110 is stored in the disk 212.

Incidentally, the authentication server 104 receives through the network 106 the image (image data) shot and acquired by the network camera 110, and, based on the received image data, creates an MOV format file and an AVI (Audio Video Interleaving) format file with respect to each predetermined time (for example, one hour). In the present embodiment, it is assumed that the UDP (User Datagram Protocol) is used to transfer the image data from the network camera 110 to the authentication server 104.

Here, it should be noted that the MOV format file is the moving image file to be used in the basic software “QuickTime” (developed by Apple Inc. in United States of America) for handling multimedia by a computer. The MOV format file is used as a management file because it can manage a start hour and the number of frames per second (frame per second). If a moving image is recorded as the MOV format file, the data size becomes large by reason of a characteristic of data format. For this reason, in the present embodiment, the MOV format file is used only as the management file, and the actual image data is stored in the disk 212 as the AVI format file in a Motion-JPEG (Joint Photographic Experts Group) format. Here, it should be noted that the AVI format file in the Motion-JPEG format is the file for managing only the number of frames without notion of time. Incidentally, it should be noted that the AVI format is the format for handling a moving image with voice by the OS (operation system) “Windows™” developed by Microsoft Corporation in United States of America, and the Motion-JPEG, which is one of moving image recording systems, is to continuously record JPEG-compressed images of respective frames. As such, the authentication server (recording management server) 104 creates the files of two kinds of formats with respect to each predetermined time and stores the created files in the disk 212.

The image formation device 105 includes a CPU 217 having the same function as that of the first computer 101, a memory 218, a disk 219, a network interface 224, an IC card reader 223, an operation unit 220, and an image output engine 222, which are mutually connected to others through an internal bus 221. If the IC card 209 (corresponding to the IC card 113 in FIG. 1) is inserted into the image formation device 105, the IC card reader 223 (corresponding to the IC card reader 109 in FIG. 1) reads a user name and a password written on the inserted IC card. The operation unit 220 is used to execute setting of the number of copies, and the like. The image output engine 222 receives the data and the signals from the above-described constituent elements of the image formation device 105 and executes a printing process based on the received data and signals to produce a print output 226. Here, it should be noted that, in the image formation device 105, a not-illustrated scanner engine for reading an image of an original and generating image data based on the read image may be connected to the internal bus 221.

In the first computer 101 in the information processing system configured as described above, if a user sets the IC card 209 to the IC card reader 206 and then executes printing of text data created based on a predetermined application to the image formation device 105 through the predetermined application, the predetermined application automatically acquires the user identification information from the IC card 209 through the IC card reader 206, adds the acquired user identification information to a print job produced based on the text data, and then transmits the acquired print job to the image formation device 105 through the network 106.

The image formation device 105, which received the print job through the network 106, stores the received print job on a job storage area secured in the disk 219.

The network camera 110 includes an operation unit 230, a CPU 231, a ROM 232, an imaging unit 233, a RAM 234, a disk 235, a network interface 236, and a bus 237. Moreover, the imaging unit 233 includes a camera unit capable of panning, tilting and zooming operations and an encoding unit (not illustrated).

The ROM 232 has stored therein a control program for controlling the network camera 110. Thus, the CPU 231 reads the stored control program from the ROM 232, transfers the read program to the RAM 234, and then executes the program transferred to the RAM 234, thereby controlling the network camera 110. Besides, the ROM 232 has stored therein an ID for uniquely identifying the network camera 110. Further, the imaging unit 233 shots and acquires images in response to an instruction from the CPU (control unit) 231.

Then, the CPU (control unit) 231 encodes the shot and acquired image into image data of a predetermined format, transfers the encoded image data and the ID for identifying the network camera 101 to the network interface 236, and then transmits the image data and the ID to the authentication server (recording management server) 104 through the network 106.

The disk 235 stores therein a setting information storage table. Thus, the CPU (control unit) 231 controls the panning, tilting and zooming operations by referring the setting information storage table stored in the disk 235. Here, it should be noted that “panning operation” implies the operation to swing the camera in a horizontal direction, and “tilting operation” implies the operation to swing the camera in a vertical direction. That is, if it causes the camera to shot and acquire images in a fixed direction (without swinging the camera), the above control by the CPU (control unit) 231 is unnecessary.

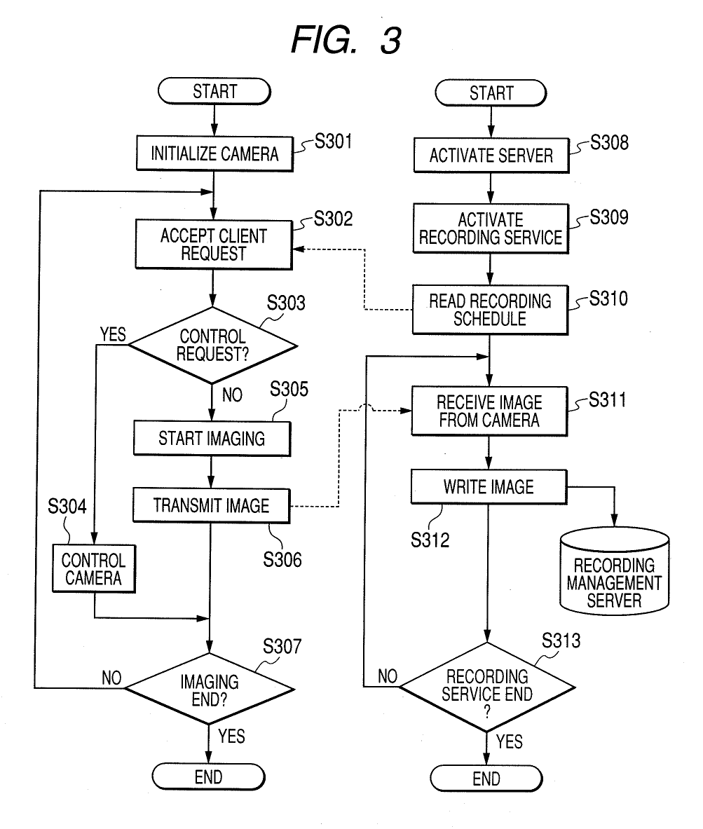

Further, the CPU (control unit) 231 accepts a camera control request and/or an imaging start request from the authentication server (recording management server) 104. In any case, the concrete processes by the network camera 110 will be described with reference to a later-described flow chart in FIG. 3.

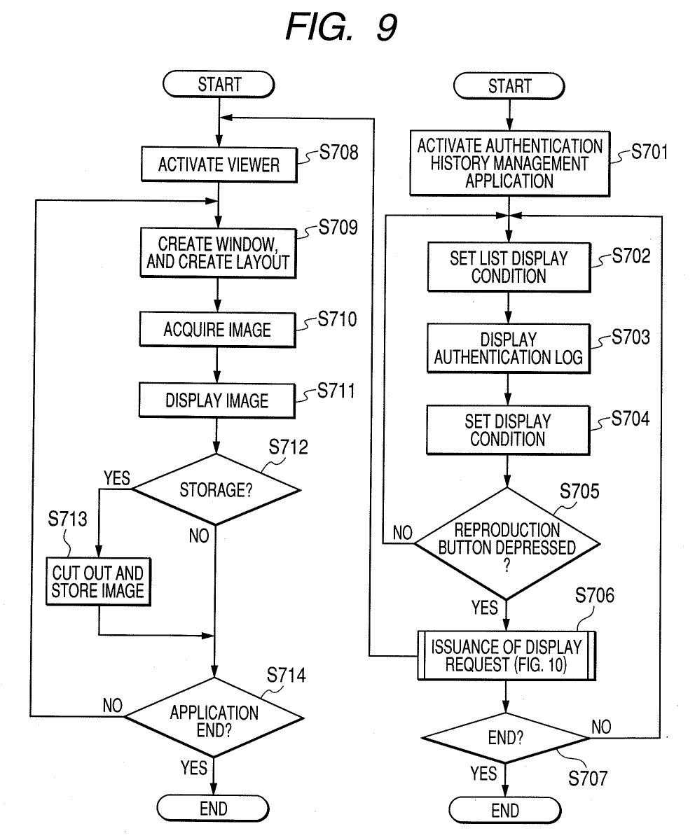

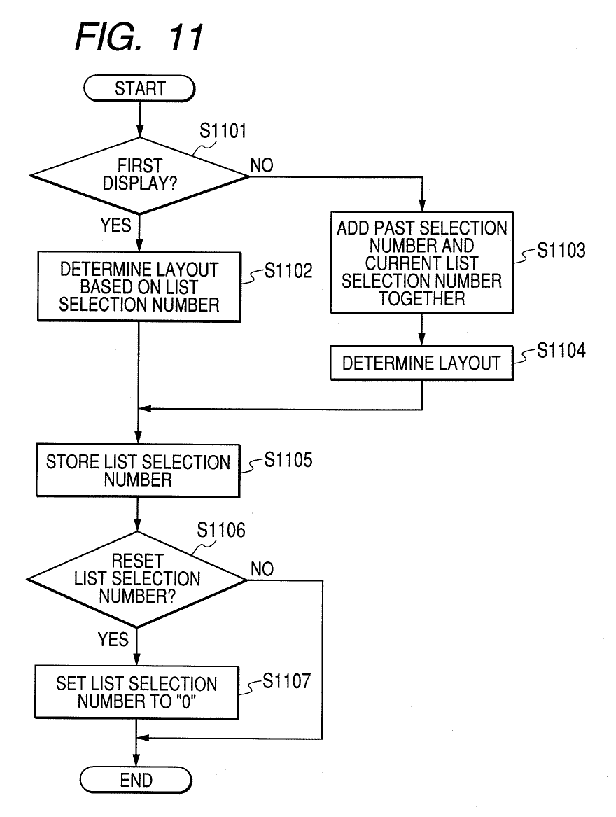

The image display control device 103 includes a CPU 240 having the same function as that of the first computer 101, a memory 241, a disk 242, a keyboard 244, a display 245, and a network interface 224, which are mutually connected to others through an internal bus 243. Here, in the image display control device 103, an image display control program according to the present invention has been stored in the disk 242. Then, the image display control program stored in the disk 242 is loaded into the memory 241 and then executed by the CPU 240. In any case, the concrete processes based on the image display control program will be described later with reference to FIGS. 9 and 11.

Hereinafter, the process that authentication and operation histories in the image formation device 105 and the image of the image formation device 105 shot and acquired by the network camera 110 are stored in the authentication server (recording management server) 104 will be described with reference to FIGS. 3 to 5.

FIG. 3 is a flow chart for describing an example of a first control processing operation in the system to which the present invention is applicable. Here, it should be noted that the first control processing operation corresponds to the process that the network camera 110 acting as the imaging device transmits the shot and acquired image data to the authentication server (recording management serve) 104. Here, it should be noted that steps S301, S302, S303, S304, S305, S306 and S307 in FIG. 3 correspond to the steps which are achieved if the CPU 231 of the network camera 110 reads and executes the program stored in the ROM 232 or the like, and steps S308, S309, S310, S311, S312 and S313 correspond to the steps which are achieved if the CPU 210 of the authentication server 104 reads the program stored in the disk 212 or the like onto the memory 211 and executes the read program.

First of all, the operation of the authentication server 104 will be described.

In the step S308, the CPU 210 of the authentication server 104 reads an image recording program from the disk 212 onto the memory 211 to activate an imaging system (server).

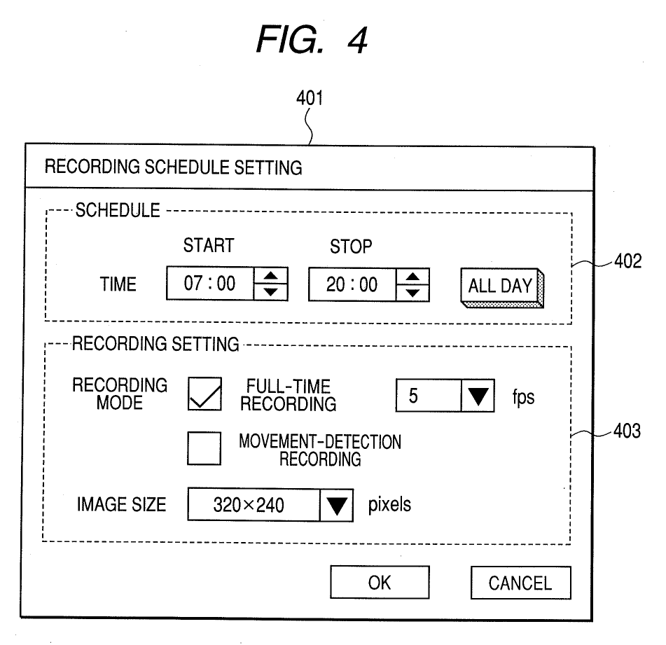

Then, in the step S309, the CPU 210 causes the display 215 to display a recording schedule setting screen 401 illustrated in FIG. 4, according to the activated image recording program, thereby activating a recording service. In this recording service, the user can input a recording condition through the recording schedule setting screen 401. Here, the recording schedule setting screen 401 will be described with reference to FIG. 4.

FIG. 4 is a schematic diagram for describing an example of the screen for setting a recording schedule in the system to which the present invention is applicable.

As illustrated in FIG. 4, the recording schedule setting screen 401 includes a schedule setting area 402 and a recording setting area 403.

Further, the schedule setting area 402 includes the items for setting a time zone that the network camera 110 executes image recording, so that a start time and a stop time can be set by the user through these items. Furthermore, the schedule setting area 402 includes an “all day” button. Thus, the network camera 110 executes the image recording all day if the “all day” button is depressed.

The recording setting area 403 includes the items for selecting, as recording modes, whether to always execute the image recording (full-time recording) or to execute the image recording if a movement is detected (movement-detection recording). Here, it should be noted that the movement-detection recording corresponds to the recording mode that the image recording is executed if it is detected that a subject shot by the network camera 110 moves. On the other hand, if the full-time recording is set, the image recording is always executed in the time zone set in the schedule setting area 402. Incidentally, if the recording mode is selected, it is possible to set a frame rate (fps: frames per second) which indicates how many frames the images can be recorded per second. That is, as illustrated in FIG. 4, if “5” fps is set as the frame rate, the images corresponding to five frames are recorded for one second. Further, the recording setting area 403 includes the image size setting item for setting the size of the image to be recorded. For example, as illustrated in FIG. 4, the image of which the size is lateral 320 pixels and longitudinal 240 pixels is recorded.

In any case, the contents set on the recording schedule setting screen 401 are decided if the “OK” button is depressed.

Hereinafter, the processes in the flow chart of FIG. 3 will be again described.

If the “OK” button is depressed on the recording schedule setting screen 401, in the step S310, the CPU 210 reads the set contents (that is, a recording schedule) decided in response to the depression of the “OK” button on the recording schedule setting screen 401, and transmits the recording schedule to the network camera 110. More specifically, the CPU 210 transmits a session start request to the network camera 110 through the LAN 106, and, after a session is established, transmits a recording condition (that is, the recording schedule and recording settings) to the network camera 110. Incidentally, if a current hour is between the start time and the stop time both set in the schedule setting area 402, or if the “all day” is set as the recording schedule, it is assumed that the CPU 210 transmits a recording request in addition to the session start request.

The recording setting to the network camera 110 ends in this step (S310). The processes in the step S311 and the following steps are executed if the recorded image (image data) is transmitted from the network camera 110.

More specifically, in the step S311, the CPU 210 receives the image data from the network camera 110, and stores the received image data in the memory 211. Further, the CPU 210 creates the MOV format file and the AVI format file both described above, and temporarily stores one by one the received image data as the AVI format file. As described above, the MOV format file is the file capable of managing the start time and the number of frames per second (frames per second).

Subsequently, in the step S312, if the data of AVI format for a predetermined time (for example, one hour) is stored, the CPU 210 closes the MOV format file and the AVI format file, and stores them in the disk 212. After then, the image data transmitted from the network camera 110 is stored as a new AVI format file, and also an MOV format file is newly created.

Next, in the step S313, it is determined by the CPU 210 of the authentication server 104 whether or not the end of the recording service is instructed. If it is determined that the end of the recording service is instructed, the CPU 210 ends the program. On the other hand, if it is determined in the step S313 that the end of the recording service is not instructed, the CPU 210 returns the process to the step S311.

Subsequently, the operation of the network camera 110 which acts as the imaging device will be described.

If the power source of the network camera 110 is turned on, in the step S301, the system is activated. Then, the CPU 231 of the network camera 110 reads a camera control program from the disk 235, and initializes the camera according to the read program. Then, the CPU 231 advances the process to the step S302.

In the step S302, if the CPU 231 newly receives (accepts) a client request, the CPU 231 advances the process to the step S303. In the present embodiment, it should be noted that the client request implies that the recording condition and the recording request are transmitted from the authentication server (recording management server) 104 to the network camera 110 in the step S310.

In the step S303, it is determined by the CPU 231 of the network camera 110 whether or not the request accepted in the step S302 is a control request concerning the camera. Here, it should be noted that the request concerning the camera indicates the recording condition which includes the recording schedule and the recording setting. In any case, if it is determined in the step S303 that the accepted request is the control request concerning the camera, the CPU 231 advances the process to the step S304.

On the other hand, if it is determined that the accepted request is not the control request concerning the camera but is the recording request, the CPU 231 advances the process to the step S305.

In the step S304, the CPU 231 controls the camera according to the recording condition transmitted from the authentication server (recording management server) 104. More specifically, the recording schedule defined in the recording condition is stored in the disk 235, and it is then determined whether or not the current hour is within the time set in the recording schedule. If it is determined that the current hour is within the time set in the recording schedule, the recording request for starting the imaging is internally generated. Then, based on the internally generated recording request, it is determined in the step S303 that the accepted request is the recording request, and the CPU 231 thus advances the process to the step S305.

Moreover, in the step S304, if it is determined that the current hour is not within the time set in the recording schedule, the camera control is on standby until the current hour comes to be within the time zone set in the recording schedule. Further, the CPU 231 stores, in the disk 235, the recording setting defined in the recording condition, and sets the recording mode and the image size to the imaging unit 233. After that, the imaging unit 233 executes the imaging according to the relevant recording setting.

After the camera control in the step S304, the CPU 231 advances the process to the step S307 to determine whether or not the imaging ends. Then, if it is determined that the imaging does not end, or if the imaging does not yet start, the CPU 231 returns the process to the step S302 to wait for a next client request or an internal recording request.

Further, in the step S305, the CPU 231 causes the imaging unit 233 to start the imaging according to the recording request. The imaging unit 233 sequentially stores the shot and acquired images in the RAM 234 according to the set recording mode and the set image size. Then, in the step S306, the CPU 231 transmits the shot and acquired images and the ID for specifying the network camera stored in the RAM 234 to the recording management server 104 through the network interface 236.

Subsequently, in the step S307, it is determined by the CPU 231 whether or not to end the imaging. Here, if it is determined not to end the imaging, the CPU 231 returns the process to the step S302 to further determine whether or not to accept a new client request, as continuing the imaging by the imaging unit 233.

On the other hand, if it is determined by the CPU 231 in the step S307 to end the imaging (that is, it is determined that the time zone defined in the recording schedule ends), the CPU 231 ends the process.

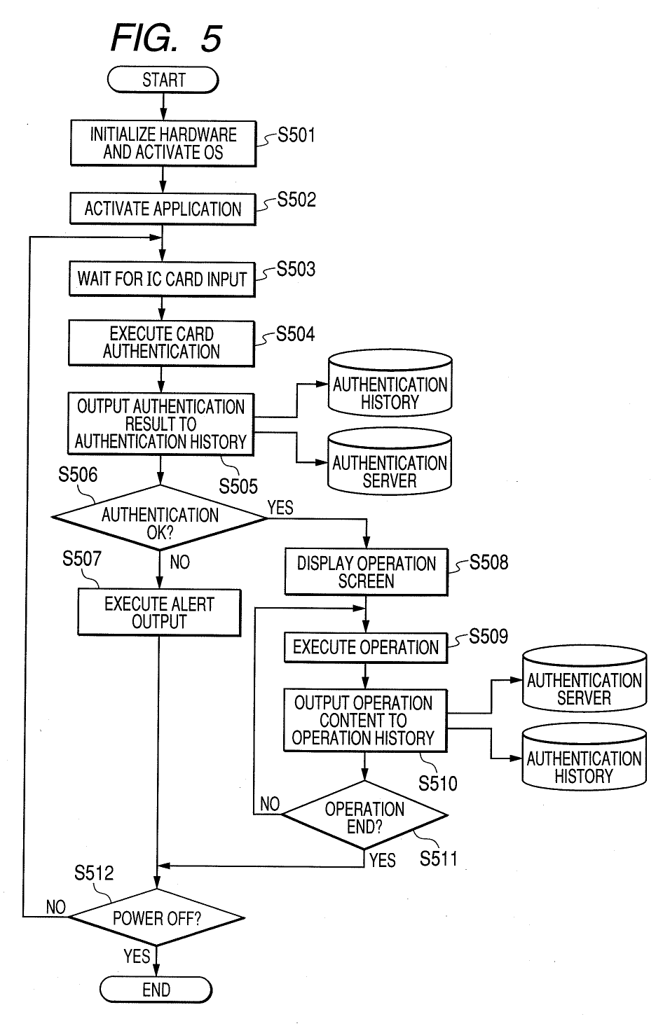

FIG. 5 is a flow chart for describing an example of a second control processing operation in the system to which the present invention is applicable. Here, it should be noted that the second control processing operation corresponds to an IC card authentication process and a storage process of storing the operation contents as an operation history in the image formation device 105. Incidentally, it should be noted that steps S501, S502, S503, S504, S505, S506, S507, S508, S509, S510, S511 and S512 in FIG. 5 correspond to the steps which are achieved if the CPU 217 of the image formation device 105 reads and executes the control program stored in the memory 218.

Initially, in the step S501, if the power source of the image formation device 105 is turned on, the CPU 217 of the image formation device 105 initializes hardware such as a scanner, a printer and the like, and activates an OS (operation system).

Then, in the step S502, the CPU 217 activates an authentication application which will operate on the OS. Thus, the environment that the image formation device 105 can execute IC card authentication is established.

Next, in the step S503, it is determined by the CPU 217 whether or not the IC card 209 is inserted into the IC card reader 223 and a user name and a password written on the inserted IC card are input (wait for IC card input). Here, it is assumed that, in the present embodiment, the user name (or a user ID) and the password have been written on the IC card. If it is determined in the step S503 that the user name and the password are input from the IC card, the CPU 217 advances the process to the step S504.

In the step S504, the CPU 217 transfers the input user name and the input password to the authentication server 104, and then receives an authentication result from the authentication server 104 (card authentication). Then, it is determined by the authentication server 104 whether or not the user name and the password received from the image formation device 105 respectively coincide with the user name and the password managed by the authentication server 104. If these user names and passwords coincide, the authentication server 104 returns to the CPU 217 information indicating authentication. On the other hand, if these user names and passwords do not coincide, the authentication server 104 returns to the CPU 217 information indicating non-authentication.

In the step S505, the CPU 217 writes, into an authentication history file, the authentication result returned from the authentication server 104, and then stores the authentication history file in the disk 219. Further, if the CPU 217 regularly transmits the authentication history files to the authentication server 104, also the authentication server 104 manages the authentication history of the image formation device 105. For this reason, it is possible in the authentication server 104 to manage the authentication histories of plural image formation devices on the network 106. Incidentally, in the authentication server 104, the authentication history files for the ID of each of the plural image formation devices provided on the network 106 are stored in the disk 212.

Next, in the step S506, it is determined by the CPU 217 whether or not the authentication result is “OK”. Then, the CPU 217 advances the process to the step S508 if it is determined that the authentication result is “OK”. On the other hand, the CPU 217 advances the process to the step S507 if it is determined that the authentication result is not “OK”.

In the step S507, the CPU 217 executes an alert output by displaying a warning indicating that the authentication result was not “OK” and/or ringing a buzzer. Then, the CPU 217 advances the process to the step S512.

On the other hand, in the step S508, the CPU 217 causes the operation unit 220 to display an operation screen according to the authentication result “OK”. Thus, the user can operate the image formation device 105.

Next, in the step S509, the CPU 217 controls the operation of the image formation device 105 according to operation instructions input by the user (executing the operation). More specifically, the CPU 217 executes a copying operation, a send processing operation, and a facsimile processing operation. In the copying operation, an original is read by the scanner, and the read original is output as prints. In the send processing operation, the read original is transmitted to a client PC through the network. In the facsimile processing operation, the read original is transmitted through a public network.

Subsequently, in the step S510, the CPU 217 associates the user name and the hour in authentication history with the operation content executed in the step S509, writes them into the operation history file, and then stores in the disk 219 the acquired data as the operation history. Further, if the CPU 217 regularly transmits the operation history files to the authentication server 104, also the authentication server 104 manages the operation history of the image formation device 105. For this reason, it is possible in the authentication server 104 to manage the operation histories of the plural image formation devices on the network. Incidentally, in the authentication server 104, the operation history files for the ID of each of the plural image formation devices provided on the network 106 are stored in the disk 212.

Then, in the step S511, it is determined by the CPU 217 whether or not the operation ends (that is, it is determined whether or not the device is logged out). More specifically, if a log-out button provided on the operation unit 220 is depressed by the user, or if any operation is not executed for a predetermined time (for example, one minute) from the latest operation, it is determined that the device is logged out. In any case, if it is determined in the step S511 that the operation does not end, the CPU 217 returns the process to the step S509.

On the other hand, if it is determined in the step S511 that the operation ends, the CPU 217 advances the process to the step S512.

In the step S512, it is determined by the CPU 217 whether or not power off is instructed by a user's operation on the operation unit 220. Then, if it is determined that power off is instructed, the CPU 217 ends the system and shuts down the power source of the image formation device 105. On the other hand, if it is determined that power off is not instructed, the CPU 217 returns the process to the step S503 to wait for next authentication by an IC card.

As described above, according to the operations of the flow charts illustrated in FIGS. 3 and 5, it is possible to store the authentication history and the operation history in the image formation device 105 and the image of the image formation device 105 shot by the network camera 110 in the authentication server (recording management server) 104. Then, the authentication server 104 associates the hour information included in the authentication history and the hour information included in the operation history in the image formation device 105 stored in the disk 212 and with the image shot by the network camera 110, particularly the imaging (shooting) start hour included in the MOV format file, and manages these data, thereby enabling to specify the shot image of a user from the authentication hour of the relevant user.

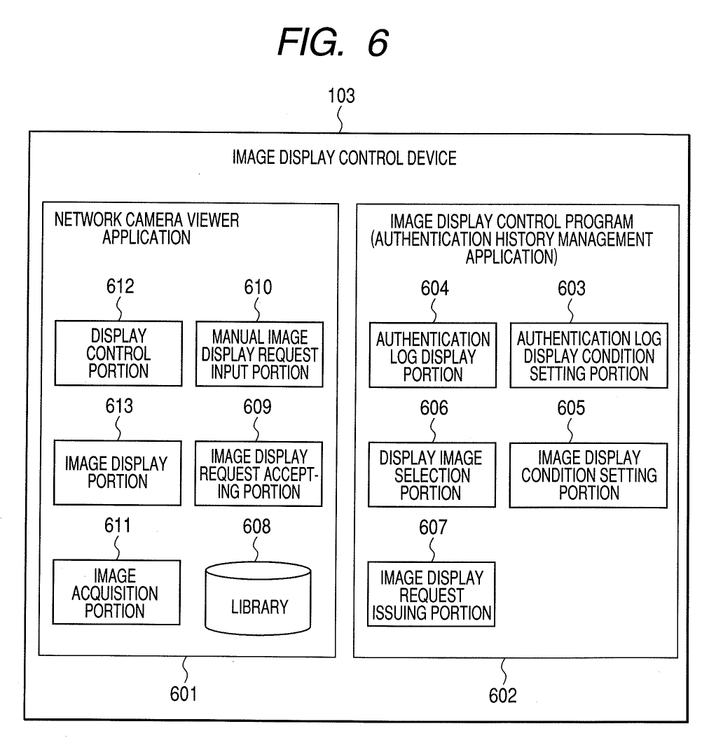

Hereinafter, the constitution and the process of the image display control unit 103 will be described with reference to FIGS. 6 to 11.

Initially, FIG. 6 is a functional block diagram for describing the functions of the image display control device 103.

As illustrated in FIG. 6, the image display control device 103 has stored therein an image display control program 602 and a network camera viewer application (also, called an image display application) 601, as executable software modules.

Although the image display control program 602 and the network camera viewer application 601 have been stored in the disk 242, they are read onto the memory 241 and then actually executed by the CPU 240.

The network camera viewer application 601 is the application for displaying the image stored in the recording management server (the authentication server in the present embodiment) 104. To display the image, the user initially has to designate at least a camera identification code (or a camera ID) to specify the image to be displayed.

If only the camera ID is designated, an image acquisition portion 611 of the network camera viewer application 601 requests image acquisition of the designated camera ID to the recording management server 104, and acquires a live image (that is, a current image) of the camera corresponding to the designated camera ID. Then, the acquired image is displayed by an image display portion 613.

Further, in the case where the camera ID is designated, if the hour information is simultaneously designated, the image acquisition portion 611 adds the hour information to the camera ID, and requests the image acquisition to the recording management server 104. Then, the recording management server 104 returns, to the image display control device 103, the image acquired by the camera corresponding to the designated camera ID at the designated hour. Thus, the network camera viewer application 601 can display the recording image acquired by the user-desired camera at the user-desired hour.

Incidentally, it should be noted that the camera ID desired by the user and the hour information indicating the shooting hour of the image to be displayed are input by using a manual image display request input portion 610. More specifically, by using the manual image display request input portion 610, the user can manually input the camera ID, the hour information, and also a display size.

Although the display size is equivalent to a predetermined default value (320×240 pixels), it is possible to input an arbitrary value through the manual image display request input portion 610. This is necessary to display plural images simultaneously. Then, a display control portion 612 resizes the acquired image into the display size of the image to be actually displayed, according to the designated display size, and causes the image display portion 613 to display the resized image.

In the present invention, an image display request accepting portion 609 is provided in the network camera viewer application 601 so as to be able to instruct the camera ID, the hour information and the display size internally from another control program (for example, the image display control program 602), by using an API (application programming interface) prepared in a library 608. Here, it should be noted that the API implies a set of functions and commands provided by a DLL (dynamic link library) file or the like, and a set of codes for calling them.

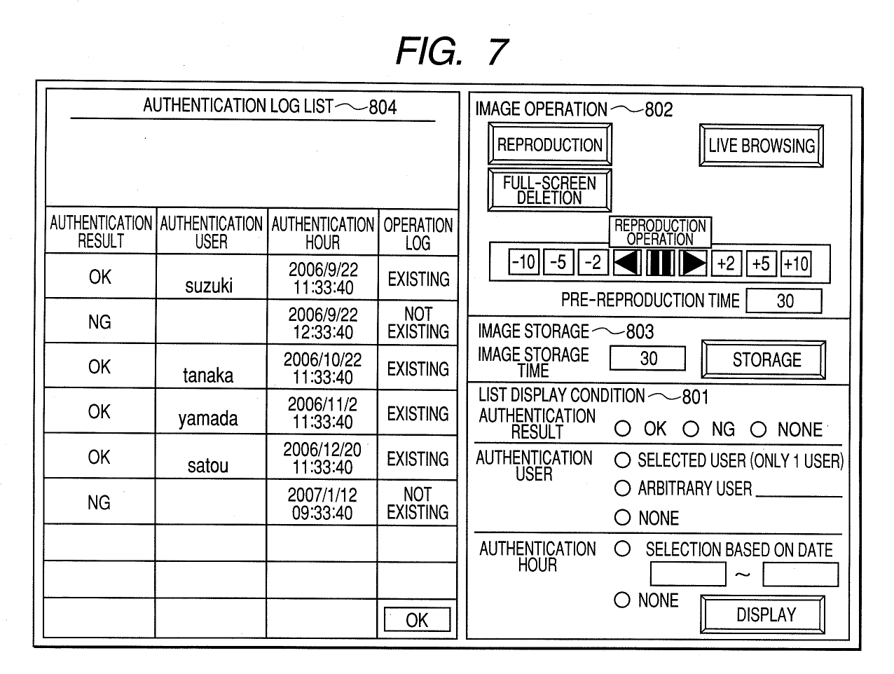

The image display control program 602, which is the application for managing the authentication histories, can display a list of the authentication histories of the image formation devices stored in the authentication server 104. First, the user can set a condition for displaying the authentication history through an authentication log display condition setting portion 603. More specifically, the authentication log display condition setting portion 603 displays a screen illustrated in FIG. 7 by using an authentication log display portion 604. Then, the displayed screen will be described with reference to FIG. 7.

FIG. 7 is a schematic diagram illustrating an example of the screen for setting an authentication list, list display conditions and recording operation conditions of the image display control device 103.

In a list display condition setting area 801 illustrated in FIG. 7, the user can designate which of authentication results “OK”, “NG” and “none” should be displayed in the authentication history. Further, in the list display condition setting area 801, the user can designate which of authentication users “selected user”, “arbitrary user” and “no user designation (none)” should be displayed in the authentication history.

In an authentication log list area 804 illustrated at the left of FIG. 7, a list of several authentication logs nearest from the current hour is displayed. Here, the authentication logs to be displayed may be acquired from either the authentication server 104 or the image formation device 105. In the state that one of the authentication logs has been selected from the authentication log list, if the authentication user “selected user” is selected in the list display condition setting area 801, the authentication list of the selected user is selected and displayed. Besides, if the authentication user “arbitrary user” is selected in the list display condition setting area 801, the input section at the right of the authentication user “arbitrary user” becomes available. Thus, the user can designate an arbitrary user name in this area by using a not-illustrated keyboard or the like.

Further, in the list display condition setting area 801, the user can designate an authentication hour based on an arbitrary date.

Such a search condition set in the list display condition setting area 801 as described above is set by the authentication log display condition setting portion 603, and then transmitted to the authentication server 104. Subsequently, in the authentication server 104, an authentication history which coincides with the transmitted condition is extracted and returned to the image display control device 103. The returned authentication history is displayed as the authentication log list in the authentication log list area 804 by using the authentication log display portion 604.

Incidentally, in the image display control device according to the present invention, it is possible to instruct reproduction of the recorded image in the state that one or more lists have been selected from the log list in the authentication log list area 804 illustrated in FIG. 7.

In an image operation area 802 illustrated in FIG. 7, a “reproduction” button, a “live browsing” button, a “full-screen deletion” button, “reproduction” buttons and a “pre-reproduction time” input section are provided.

Here, the “reproduction” button is the button for instructing the network camera viewer application 601 to reproduce and display the recorded image.

The “live browsing” button is the button for instructing the network camera viewer application 601 to change over from the current image to a live image (that is, a currently shot camera image).

The “full-screen deletion” button is the button for instructing the network camera viewer application 601 to delete the screens of all the camera images being displayed.

The “reproduction” buttons include several buttons. More specifically, the central button in the “reproduction” buttons indicates that the image to be displayed is reproduced at same speed. As plus values of the buttons increase, they indicate that the image is displayed at higher speed. Namely, it implies a fast forward. On the other hand, as minus values of the buttons increase, they indicate that the image is displayed at lower speed.

Further, the “pre-reproduction time” input section is the section for instructing the network camera viewer application 601 to reproduce the image from the point of time precedent to the authentication hour of the authentication log by the input value (a unit is “seconds”). It is possibly by designating the “pre-reproduction time” to reproduce the recording image shot previous to the authentication hour of the authentication log. Thus, it is possible to easily reproduce a scene that the user executes the operation for authentication.

Furthermore, an image storage area 803 includes an “image storage time” input section and a “storage” button. That is, it is possible by using the “image storage time” input section and the “storage” button to instruct the network camera viewer application 601 to extract from the recording image the MOV format file corresponding to a designated image storage time, and store the extracted file as another file.

The contents which are designated in the image operation area 802 and the image storage area 803 are set as a display condition by an image display condition setting portion 605, and the set display condition is given to an image display request issuing portion 607.

Further, a display image selection portion 606 has a function of selecting the list to be displayed. Thus, it is possible by the display image selection portion 606 to select one of more lists in the authentication log list area 804. If one list is selected on the relevant operation screen, the color of the selected list is reversed so as to be able to indicate a selected state. Incidentally, if the “reproduction” button is depressed in the state that one or more lists have been selected, the selected authentication history is given to the image display request issuing portion 607.

The image display request issuing portion 607 acquires the hour information to be displayed, from the authentication history instructed from the display image selection portion 606. Further, the image display request issuing portion 607 acquires the camera ID to be displayed, from the authentication history. Here, it should be noted that, in the authentication history, the image formation device 105 concerning the relevant authentication history and the camera ID of the network camera which records the images of the vicinity of the operation unit on the image formation device 105 are associated with each other. Moreover, the image display request issuing portion 607 acquires pre-reproduction time information from the display condition designated from the image display condition setting portion 605.

Subsequently, the image display request issuing portion 607 calculates the hour when displaying starts, by subtracting a pre-reproduction time from the acquired authentication hour. Then, the image display request issuing portion 607 issues an image display request to the image display request accepting portion 609 of the network camera viewer application 601 by using the API prepared in the library 608 of the network camera viewer application 601.

Hereinafter, the API issued by the image display request issuing portion 607 will be described. First, each command of the API starts by “CameraViewerStart( )” and ends by “CameraViewerEnd( )”, and actual commands are described between these commands. Here, it should be noted that plural commands may be called between “CameraViewerStart( )” and “CameraViewerEnd( )”. For the API of the image display request, two commands, that is, the command for image window display and the command for reproduction start, are necessary. Further, the API of the image window display is “C: int AddViewer (cam_id, long x, long y, long w, long h, viewID)”.

Here, it should be noted that “cam_id” implies the camera ID, “long x, long y” implies the window display position, “long w, long h” implies the display size, and “viewID” implies the viewer window ID. Moreover, the API of the reproduction start is “C: int PlayViewer (viewID, long start_time, long speed).

Here, it should be noted that “viewID” implies the viewer window ID, “long start_time” implies the start hour, and “long speed” implies the reproduction speed (−10, −5, −2, 0, +2, +5, +10).

In a case where the image display request accepting portion 609 responds to the API called from another program, the network camera viewer application 601 accepts the relevant API through the image display request accepting portion 609. With respect to the accepted API, as well as the request received by the manual image display request input portion 610, the image acquisition portion 611 transmits the image request to the recording management server 104 with the camera ID and the display hour (start hour) as arguments. Then, the image display portion 613 displays the acquired image on the viewer.

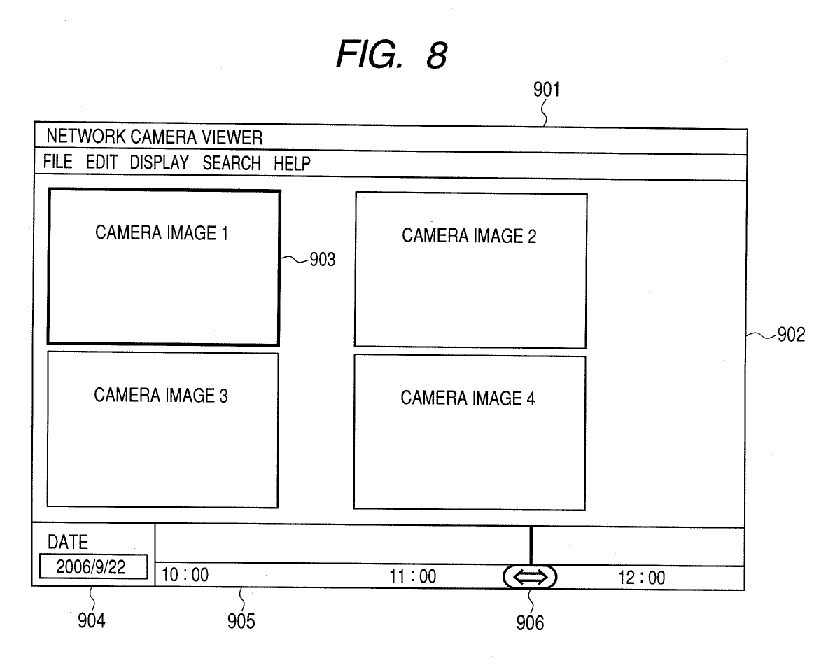

Subsequently, a viewer screen of the network camera viewer application will be described with reference to FIG. 8.

FIG. 8 is a schematic diagram for describing the viewer screen to be displayed based on the network camera viewer application 601.

In FIG. 8, a viewer screen 901, which is created by the network camera viewer application 601, is displayed on the display 245 of the image display control device 103.

An area 902 is the area for displaying camera images. More specifically, the camera images manually designated by the user and/or designated by the API from another control program are displayed in the area 902.

A window 903 is used to display the camera image. In FIG. 8, four windows are displayed respectively for camera images 1 to 4. More specifically, in FIG. 8, since the camera image 1 is being selected, the window 903 is displayed with the thickened frame so as to imply the selected state.

A section 904 is used to indicate the display date of the selected camera image, and a section 905 is used to indicate the display hour of the selected camera image.

It is assumed that, for example, the camera image 1 is displayed based on the authentication history of the user name “suzuki” and the authentication result “OK” as illustrated in FIG. 7. Consequently, since the camera image 1 is the image at the authentication hour “11:33:40”, a slide bar 906 is positioned in the vicinity of “11:30 AM” in the section 905. Here, since the slide bar 906 is slidable from side to side, it is possible to change the display hour of the camera image by properly sliding the slide bar 906.

Subsequently, the control flow in the image display control device 103 will be described with reference to FIGS. 9 to 11.

FIG. 9 is a flow chart for describing an example of a third control processing operation in the system to which the present invention is applicable. Here, it should be noted that the third control processing operation corresponds to a control process in the image display control device 103. Incidentally, it should be noted that steps S701, S702, S703, S704, S705, S706 and S707 in FIG. 9 correspond to the steps which are executed by the image display control program (or an authentication history management application) 602. Further, it should be noted that steps S708, S709, S710, S711, S712, S713 and S714 in FIG. 9 correspond to the steps which are executed by the network camera viewer application 601. In any case, since both the programs are executed by the CPU 240, the control flow in FIG. 9 will be described as the control operation by the CPU 240.

Initially, in the step S701, the CPU 240 activates the authentication history management application (image display control program) 602.

Then, in the step S702, the CPU 240 activates the authentication log display condition setting portion 603 to set the list display condition. Here, as described above, the list display condition is set in the list display condition setting area 801 illustrated in FIG. 7.

In the step S703, the CPU 240 activates the authentication log display portion 604 to display the authentication log in the authentication log list area 804.

In the step S704, the CPU 240 activates the image display condition setting portion 605 to set the display condition. Here, it should be noted that the display condition is the condition which is set through the image operation area 802 illustrated in FIG. 7, and that the display condition includes the information such as the reproduction speed, the pre-reproduction time, and the like.

In the step S705, it is determined by the CPU 240 whether or not the “reproduction” button in the image operation area 802 is depressed. Then, if it is determined that the “reproduction” button is depressed, the CPU 240 advances the process to the step S706. On the other hand, if it is determined that the “reproduction” button is not depressed, the CPU 240 returns the process to the step S702.

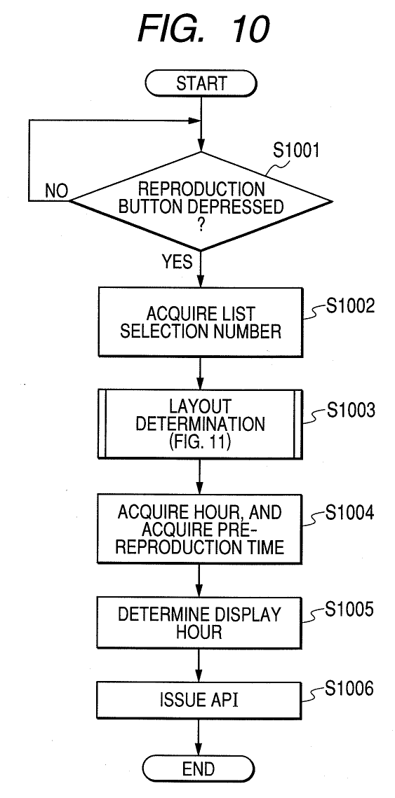

In the step S706, the CPU 240 issues the display request to the network camera viewer application 601. Here, the display request is a function which is acquired by adding the argument of each condition to the API prepared in the above-described library 608. In any case, such a display request issuing process will be described in detail with reference to later-described FIGS. 10 and 11.

In the step S707, it is determined by the CPU 240 whether or not to end the authentication history management application (image display control program) 602 (that is, it is determined whether or not an end of the relevant program is instructed). Then, if it is determined not to end the authentication history management application 602 (that is, it is determined that the end of the relevant program is not instructed), the CPU 240 returns the process to the step S702. On the other hand, if it is determined to end the authentication history management application 602, the CPU 240 ends the process.

Next, the operation of the network camera viewer application 601 will be described.

In the step S708, the CPU 240 activates the network camera viewer application 601. Thus, the display request issued by the authentication history management application 602 is accepted by the image display request accepting portion 609.

Next, in the step S709, the CPU 240 activates the display control portion 612 to create the window for displaying camera images, thereby creating the layout of the viewer screen 901 (FIG. 8). As described above, the size of the window is determined based on the display size included in the display request issued by the authentication history management application 602, and the layout is determined based on the positions of the respective windows included in the display request issued by the authentication history management application 602.

In the step S710, the CPU 240 activates the image acquisition portion 611 to issue an image acquisition request to the recording management server 104, and thus acquires the necessary images from the recording management server 104. At that time, the camera ID and display hour information are sent as the image acquisition request to the recording management server 104. Also, as described above, the camera ID and the display hour information are included in the display request issued by the authentication history management application 602.

In the step S711, the CPU 240 activates the display control portion 612 and the image display portion 613 to display the image acquired in the step S710.

In the step S712, it is determined by the CPU 240 whether or not image storage is instructed. Here, such an instruction of the image storage is the API issued by the authentication history management application 602, and this API is issued if the “storage” button in the image storage area 803 of FIG. 7 is depressed. Then, if it is determined in the step S712 that the image storage is instructed, the CPU 240 advances the process to the step S713. On the other hand, if it is determined in the step S712 that the image storage is not instructed, the CPU 240 advances the process directly to the step S714.

In the step S713, the CPU 240 cuts out the displayed images of plural frames as the MOV format files, and then stores the cut-out images in the disk 242. After then, the CPU 240 advances the process to the step S714.

In the step S714, it is determined by the CPU 240 whether or not to end the network camera viewer application 601 (that is, it is determined whether or not an end of the relevant program is instructed). Then, if it is determined not to end the network camera viewer application 601, the CPU 240 returns the process to the step S709. On the other hand, if it is determined to end the network camera viewer application 601, the CPU 240 ends the process.

Subsequently, the detail of the display request issuing process in the step S706 of FIG. 9 will be described with reference to FIG. 10.

FIG. 10 is a flow chart for describing an example of a fourth control processing operation in the system to which the present invention is applicable. Here, it should be noted that the fourth control processing operation corresponds to the display request issuing process in the step S706 of FIG. 9. Incidentally, it should be noted that steps S1001, S1002, S1003, S1004, S1005 and S1006 in FIG. 10 correspond to the steps which are executed by the image display request issuing portion 607. Since the processes of the above steps are executed by the CPU 240, the control flow in FIG. 10 will be described as the control operation by the CPU 240.

In the step S1001, it is determined by the CPU 240 whether or not the “reproduction” button in the image operation area 802 is depressed. This process corresponds to the process in the step S705 of FIG. 9.

Then, in the step S1002, the CPU 240 acquires the list selection number. Here, it should be noted that the list selection number indicates the number of authentication histories being selected in the authentication log list area 804.

In the step S1003, the CPU 240 determines the layout of the camera image windows of the network camera viewer application 601 based on the list selection number acquired in the step S1002. For example, if the acquired list selection number is “4”, the CPU 240 determines the layout so as to dispose the four camera images as illustrated in FIG. 8. Here, it should be noted that the layout may be previously prepared according to the list selection number or may be determined by calculating the widths and heights of the windows every time the list selection number is acquired.

Next, in the step S1004, the CPU 240 acquires the authentication hour of the authentication history to be displayed, and the pre-reproduction time set in the “pre-reproduction time” input section in the image operation area 802 illustrated in FIG. 7.

Then, in the step S1005, the CPU 240 determines the display hour by subtracting the pre-reproduction time from the authentication hour.

Subsequently, in the step S1006, the CPU 240 issues the image window display API and the reproduction start API by using the layout and the image size determined in the step S1003 and the display hour determined in the step S1005 as the arguments, and then ends the process.

As just described, in the case where the “reproduction” button in the image operation area 802 is depressed (that is, reproduction is instructed) in the state that the plural authentication histories are being selected in the authentication log list area 804, the CPU 240 automatically determines the layout of each camera image from the list selection number, determines the display hour from the authentication hour and the pre-reproduction time, and issues the image display request to the network camera viewer application 601 without any user's manual operation. Thus, it is possible for the user to easily display the recording images corresponding to the plural desired authentication histories.

Subsequently, the detail of the layout determination process in the step S1003 of FIG. 10 will be described with reference to FIG. 11.

FIG. 11 is a flow chart for describing an example of a fifth control processing operation in the system to which the present invention is applicable. Here, it should be noted that the fifth control processing operation corresponds to the layout determination process in the step S1003 of FIG. 10. Incidentally, it should be noted that steps S1101, S1102, S1103, S1104, S1105, S1106 and S1107 in FIG. 11 correspond to the steps which are executed by the image display request issuing portion 607. Since the processes of the above steps are executed by the CPU 240, the control flow in FIG. 11 will be described as the control operation by the CPU 240.

Initially, in the step S1101, it is determined by the CPU 240 whether or not first display is requested. More specifically, it is determined whether or not a first display request is issued after the activation of the authentication history management application 602. Further, after the “full-screen deletion” button in the image operation area 802 illustrated in FIG. 7 was depressed, there is no displayed camera image on the screen. Thus, also in this case, it is determined that a first display request is issued.

If it is determined in the step S1101 that the first display request is issued, the CPU 240 advances the process to the step S1102. On the other hand, if it is determined in the step S1101 that the first display request is not issued, the CPU 140 advances the process to the step S1103.

In the step S1102, the CPU 240 determines the layout from the list selection number acquired in the step S1002 of FIG. 10, and then advances the process to the step S1105.

On the other hand, in the step S1103, the CPU 240 adds the past selection number and the current list selection number together. Here, it should be noted that the past selection number is the number of the camera images already displayed by the network camera viewer application 601. As described later, in a case where the image display request (API) is issued from the image display control program 602 the network camera viewer application 601, the image display control program 602 manages the display number of the camera images when the request is issued.

Then, in the step S1104, the CPU 240 determines the layout from the calculated selection number. As described above, is should be noted that the defined layout may be previously prepared according to the selection number or may be determined by calculating the widths and heights of the windows every time the selection number is acquired. Further, in case of determining the layout, it is set to be able to designate the camera ID and the display hour information as well as the position and the size of each camera image. This is because, as described in the next step S1105, it is necessary to store each API once transmitted to the network camera viewer application 601. Then, the CPU 204 advances the process to the step S1105.

Subsequently, in the step S1105, the CPU 240 stores the selection number in the disk 242. At that time, the CPU 240 also stores, in the disk 242, the start API and the display API transmitted to the network camera viewer application. Thus, it is possible to later use the camera ID corresponding to the camera image that the display request was past issued to the network camera viewer application, and the display hour (shooting hour).

Next, in the step S1106, it is determined by the CPU 240 whether or not a reset request is issued for the selection number. Here, it is assumed that the reset request for the selection number is issued if the “full-screen deletion” button in the image operation area 802 illustrated in FIG. 7 is depressed. Incidentally, if the “full-screen deletion” button is depressed, all the camera image windows of the network camera viewer application 601 are closed. Thus, in the step S1107, the CPU 240 changes the selection number to “0”, stores the changed selection number, and then executes the process. At the same time, in the step S1107, the CPU 240 deletes the stored API.

On the other hand, if it is determined in the step S1106 that the reset request is not issued for the selection number, the CPU 240 immediately ends the process.

As described above, according to the operation illustrated in FIG. 11, the layout which includes the newly display-requested camera image is determined in consideration of the number of the camera image windows which have been already displayed by the network camera viewer application 601. Thus, it is possible to display the camera images in appropriate layout without closing the already-displayed camera image windows.

Incidentally, it should be noted that the configurations of the above various kinds of data, the configurations of the above various kinds of screens, and the contents thereof are not limited to the above. That is, it is needless to say that various configurations and contents are applicable according to intended purposes and objects.

As described above, one exemplary embodiment is described. In addition, the present invention is also applicable to, for example, a system, a device, a method, a program, a recording medium or the like. More specifically, the present invention is applicable to a system which consists of plural devices or to a single device.

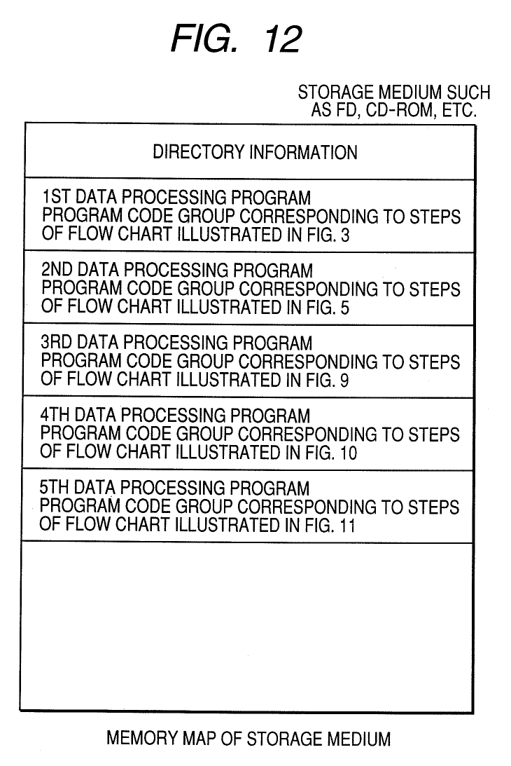

Hereinafter, the configuration of the data processing program which is readable by a device constituting a system to which the present invention is applicable will be described with reference to the memory map illustrated in FIG. 12.

FIG. 12 is a diagram for describing the memory map of a recording medium (storage medium) which stores the various data processing programs readable by the device constituting the system to which the present invention is applicable.

Although it is not illustrated specifically, also information (e.g., version information, creator information, etc.) for administrating the program groups stored in the recoding medium may occasionally be stored in the recording medium, and information (e.g., icon information for discriminatively displaying a program, etc.) depending on an OS or the like on the program reading side may occasionally be stored in the recording medium.

Moreover, the data depending on the various programs are administrated on the directory of the recording medium. Besides, a program to install various programs into a computer, a program to extract installed programs and data when the installed programs and data have been compressed, and the like are occasionally stored.

Furthermore, the functions illustrated in FIGS. 3, 5, 9, 10 and 11 may be executed by a host computer based on externally installed programs. In that case, the present invention is applicable even in a case where an information group including programs is supplied from a storage medium (such as a CD-ROM, a flash memory, an FD (floppy disk) or the like) or an external storage medium through a network to an output device.

### Other Embodiments

As described above, it is needless to say that the object of the present invention can be achieved in a case where the recording medium storing the program codes of software to realize the functions of the above embodiment is supplied to a system or a device and then a computer (or CPU or MPU) in the system or the device reads and executes the program codes stored in the recording medium.

In that case, the program codes themselves read from the recording medium realize the new functions of the present invention, whereby the recording medium storing the relevant program codes constitutes the present invention.

As the recording medium for supplying the program codes, for example, a flexible disk, a hard disk, an optical disk, a magnetooptical (MO) disk, a CR-ROM, a CD-R, a DVD-ROM, a magnetic tape, a nonvolatile memory card, a ROM, an EEPROM, a silicon disk or the like can be used.

Further, it is needless to say that the present invention includes not only a case where the functions of the above embodiment are realized by executing the program codes read by the computer, but also a case where an OS (operating system) or the like running on the computer executes a part or all of the actual processes on the basis of instructions of the program codes and thus the functions of the above embodiment are realized by the processes.

Furthermore, it is needless to say that the present invention also includes a case where, after the program codes read out of the recording medium are written into a function expansion board inserted in the computer or a memory of a function expansion unit connected to the computer, a CPU or the like provided in the function expansion board or the function expansion unit executes a part or all of the actual processes on the basis of the instructions of the program codes, and thus the functions of the above embodiment are realized by such the processes.

Besides, the present invention is applicable to a system constituted by plural devices or to a single device. Furthermore, it is needless to say that the present invention is applicable also to a case where the object of the present invention is attained by supplying a program to a system or a device. In this case, the program themselves read from the recording medium realizes the new functions of the present invention, whereby the recording medium storing the relevant program constitutes the present invention.

Besides, as a method of supplying programs, there is a method of connecting with a home page on the Internet by using a browser of a client computer, and downloading the computer program itself of the present invention or a compressed file including an automatic installing function together with the computer program into the recording medium such as a hard disk or the like.

Incidentally, it should be noted that, even if the above embodiment and its modification are combined, such a combination is also included in the present invention.

As described above, the image display control program 602 of the image display control device 103 displays the log-in history of the image formation device 105, acquires the log-in hour of the log selected by the user from the displayed log-in history, and issues the display instruction (API) to the network camera viewer application 601 based on the acquired log-in hour. Then, the network camera viewer application 601 recognizes the hour of the image to be reproduced from the received display instruction (API), acquires the image at the relevant hour from the server, and then displays the acquired image.

Further, the image display control program 602 of the image display control device 103 determines the layout for dynamically displaying the images according to the number of the logs selected and instructed to display at the same time by the user from the log-in history, and then issues the display instruction to the network camera viewer application 601 based on the determined layout.

Thus, the image at the desired hour can be displayed from the log-in history of the image formation device 105 with simple operation. Accordingly, even if the user is not skilled in operating the device, he/she can execute an adequate operation.

Moreover, it is possible by a combination of the authentication and operation logs and the image system to cope with a risk of information leakage in the image formation device 105. More specifically, (1) an effect of preventing dishonesty can be expected by recording the user who is operating the device, and (2) to specify occurrence of dishonesty and a person who is concerned with the dishonesty can be expected.

While the present invention has been described with reference to the exemplary embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2007-054123, filed Mar. 5, 2007, which is hereby incorporated by reference herein in its entirety.

What is claimed is:

1. An image display control device which can communicate with a terminal device having an authentication function, and an imaging device for acquiring an image of an operator of the terminal device, respectively through a network, the image display control device comprising:
a first display unit configured to display an authentication history list of the terminal device;
a selection unit configured to select an authentication history from the authentication history list displayed by the first display unit;
a pre-reproduction time setting unit configured to set a time for displaying the image retroactively from an authentication hour; and
a second display unit configured to display the image acquired by the imaging device, from a display start position of the image which is determined based on the authentication hour specified from the authentication history selected by the selection unit and a pre-reproduction time set by the pre-reproduction time setting unit.

2. An image display control device according to claim 1, further comprising a layout determination unit configured to determine a layout of the image to be displayed by the second display unit, based on the number of the authentication histories selected by the selection unit,
wherein the second display unit displays the image acquired by the imaging device, according to the layout determined by the layout determination unit.

3. An image display control device according to claim 1, further comprising an authentication history list display condition setting unit configured to set a display condition of the authentication history list,
wherein the first display unit displays the authentication history list based on the display condition set by the authentication history list display condition setting unit.

4. An image display control device according to claim 1, wherein
the image display control device executes an image display application for causing the second display unit to display the image,
the image display control device further comprises a request unit configured to request the image display application to display the image stored in the recording management server, and
the request unit requests the image display application to display the image, by using an application programming interface provided by a library prepared by the image display application.

5. An image display control method in an image display control device which can communicate with a terminal device having an authentication function, and an imaging device for acquiring an image of an operator of the terminal device respectively through a network, the image display control method comprising:
a first display step of displaying an authentication history list of the terminal device;
a selection step of selecting an authentication history from the authentication history list displayed in the first display step;
a pre-reproduction time setting step of setting a time for reproducing the image retroactively from an authentication hour; and
a second display step of displaying the image acquired by the imaging device, from a display start position of the image which is determined based on the authentication hour specified from the authentication history selected in the selection step and a pre-reproduction time set by the pre-reproduction time setting step.

6. A storage medium which stores therein a program for causing a computer to execute an image display control method in an image display control device which can communicate with a terminal device having an authentication function, and an imaging device for acquiring an image of an operator of the terminal device respectively through a network, the image display control method comprising:
a first display step of displaying an authentication history list of the terminal device;
a selection step of selecting an authentication history from the authentication history list displayed in the first display step;
a pre-reproduction time setting step of setting a time for reproducing the image retroactively from an authentication hour; and
a second display step of displaying the image acquired by the imaging device, from a display start position of the image which is determined based on the authentication hour specified from the authentication history selected in the selection step and a pre-reproduction time set by the pre-reproduction time setting step.
